(19) United States
(12) Patent Application Publication
(10) Pub. No.: US 2015/0248192 A1
(43) Pub. Date: Sep. 3, 2015

(54) Semi-Automated Generation of Address Components of Map Features

(71) Applicants: Lalitesh Katragadda, Bangalore (IN); Vinay Chitlangia, Bangalore (IN); Mandayam Thondanur Raghunath, Bangalore (IN); Anand Srinivasan, Bangalore (IN); Lakshminath Bhuvanagiri, Bangalore (IN)

(72) Inventors: Lalitesh Katragadda, Bangalore (IN); Vinay Chitlangia, Bangalore (IN); Mandayam Thondanur Raghunath, Bangalore (IN); Anand Srinivasan, Bangalore (IN); Lakshminath Bhuvanagiri, Bangalore (IN)

(73) Assignee: GOOGLE INC., Mountain View, CA (US)

(21) Appl. No.: 13/252,046

(22) Filed: Oct. 3, 2011

(51) Int. Cl. G06F 3/0482; G06F 3/0484; G06F 17/30

(52) U.S. Cl. CPC G06F 3/0482; G06F 17/30241; G06F 3/04842; G06F 17/30864

(57) ABSTRACT

A semi-automatic generation of addresses of map features is performed. A geographic information system includes one or more databases comprising map features. Each map feature is indexed by location, and may include an address. Each address is composed of one or more address components, such as street, city, state, country, zip code, and the like. To generate address components for a selected map feature, all polygonal map features containing or near the location of a selected map feature are identified. The strength of the matches between the location of the selected map feature and the identified polygonal features is determined. The address components corresponding to the identified polygonal features are automatically compiled and suggested to the user to be components of the address of the selected map feature based on the strength of the matches.

### BACKGROUND

1. Field of the Invention

This invention generally relates to the generation of addresses of map features, and specifically relates to suggesting address components for user-generated edits and additions to map data.

2. Description of the Related Art

Conventionally, acquiring the data necessary to create a map requires vast amounts of time and resources. The data required to create a map (‘map data”) includes geographic data, such as latitude, longitude, elevation, and location of geographic features (e.g., bodies of water, mountains, forests); political data such as country, state, and city boundaries; location of roads and points of interest (e.g., government buildings, universities, stadiums); address numbering on streets; and attributes of map features, such as whether an area is public and the nature of the surface of a street. Acquiring the details of this data traditionally required integrating multiple different data sources, and even sending expert observers to the location to be mapped. This map making process is typically performed by company which has complete quality control over the data being added to the map, thereby preventing errors in the map data.

Recent advances in mapping technology have allowed users from around the world to contribute their local knowledge to mapping databases and to participate in editing map data. One example of such technology is Google Map Maker, available at http://google.com/mapmaker, developed by Google Inc.

Because individual contributors to map data can operate largely independently of the map provider, there is a greater likelihood for errors to arise in the map data. First, there is the potential that the data entered by one user for a feature may duplicate (i.e., completely or partially overlap) the data entered for the same feature by one or more other users. Second, the quality of the data entered by various users may vary widely. Accordingly, it can be difficult to determine whether similar entries of map data are meant to represent the same entity.

### SUMMARY

In various embodiments, a semi-automatic generation of addresses of map features is performed. A geographic information system includes one or more databases comprising entries of map data. Each entry describes a map feature. Each map feature is indexed by location, and may include an address. Each address is composed of one or more address components, such as street, city, state, country, zip code, and the like. Users use client devices to view map data retrieved from the geographic information system by a geographic information server and to propose edits to the map data. Each proposed edit to the map data either proposes to add a new feature at a location or proposes to modify an existing map feature at a location. Based on the location of the edited map feature, potential address components for the map feature are automatically compiled and suggested to the user, from which the user can select address components.

In one embodiment, all polygonal features containing the location or near the location of the selected map feature are identified as having potential matches for the address components of the map feature. Examples of polygonal map features include political territories such as districts, cities, states, and countries, as well as non-political areas such as malls, complexes, and campuses. The polygonal map features may represent an address component itself (e.g., the polygon of a city represents the city), or may have one or more address components designated for it, such as street, city, state, zip code, country, etc. The strength of the potential matches for the address of the map feature are identified, and address components corresponding to the identified polygonal features are suggested to the user to be components of the address of the selected map feature based on the strength of the matches.

In one embodiment, the strength of the matches for the address components of the map feature is determined from the polygonal features containing the location or near the location of the selected map feature. If the selected map feature location is inside of the polygon, and if the polygon represents an address component (e.g., a city, a county, a state, a country, a zip code, etc.), the address component is a strong match for that component of the address of the selected map feature. If the selected map feature location is inside of the polygon of the polygonal feature, and the polygon does not represent an address component itself (e.g., the polygon represents the area of a mall, a complex, a campus, a building, etc.), the address components of the polygonal feature are transitive matches for those address components of the address of the selected map feature. If the selected map feature location is not inside of the polygon of the polygonal feature but is merely near the polygonal feature, then the address components of the polygonal feature are weak matches for those address components of the address of the selected map feature.

In one embodiment, address component options for the address of a selected map feature are displayed in order of the strength of the matches. A user selects one of the displayed address component options as the address component for the address of the selected map feature. If the user selects an address component that is not a strong match, the edit to the map feature is recorded as higher risk because it is deemed to be more likely to contain an error. Accordingly, the edit to a map feature marked as higher risk may receive special attention from a moderator who reviews map edits for quality assurance.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a computing environment of a system in accordance with an embodiment of the invention.

FIG. 2 is a flow chart illustrating a method of generating suggested address components for an address of a selected map feature, in accordance with an embodiment.

FIG. 3 is an example illustration of indexing a polygonal feature based on the S2 cells that are covered by the polygonal feature, in accordance with an embodiment.

FIG. 4 is a flow chart illustrating a method of determining the strength of matches between a location of a selected map feature and identified polygonal features, in accordance with an embodiment.

FIG. 5 is an illustration of City A being a transitive match for the city address component of feature X based on feature X's position inside the polygon marking Neighborhood D, in accordance with an embodiment.

FIG. 6 is an illustrated example of a mall street address being a transitive match for a street address component of a shop based on the shop's position inside of the polygon marking the mall.

FIG. 7 is a flow chart illustrating a method of modifying a risk associated with a user's edit, in accordance with an embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

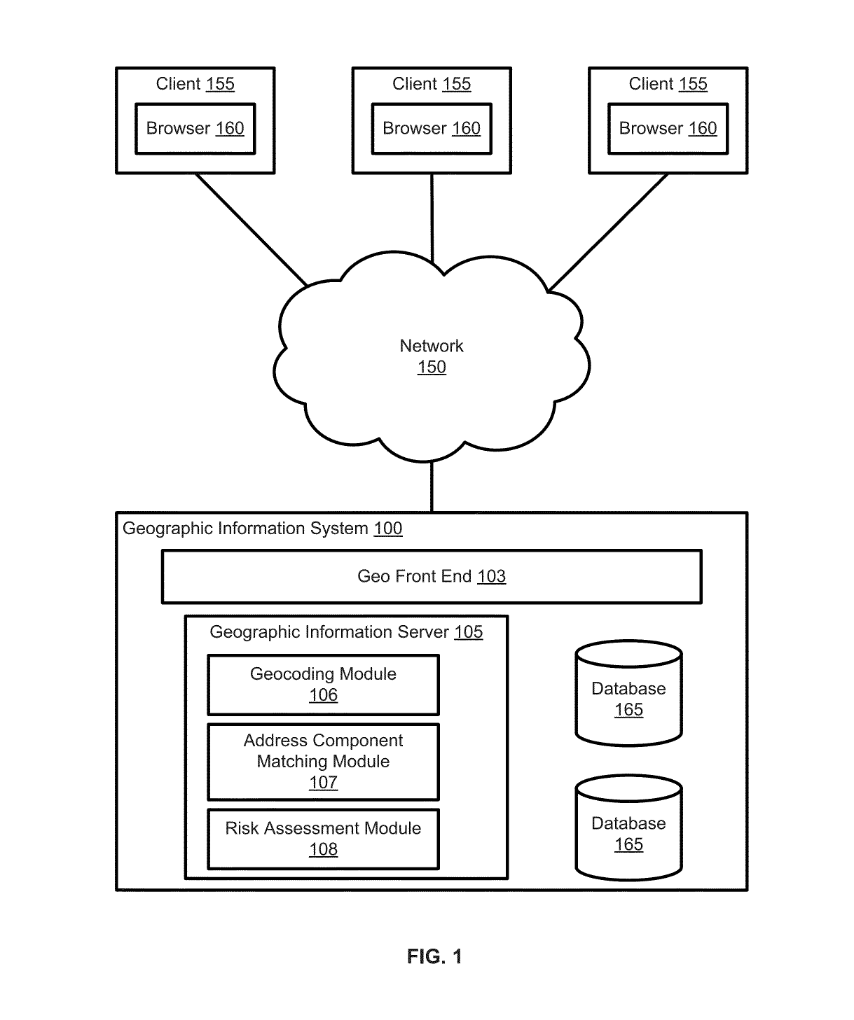

Embodiments of the invention generate address components for the addresses of map features that are edited by users. FIG. 1 is a high-level block diagram of a system environment in accordance with one embodiment. The system environment includes a plurality of clients 155 and a geographic information system 100 connected via a network 150, such as the Internet. Although three clients 155 are shown in FIG. 1 for clarity, in practice, many hundreds, thousands or more clients may be connected to the geographic information system 100 via the network 150.

A client 155 can be any user device such as a computer, a mobile device, or the like that is adapted to communicate with the geographic information system 100 over the network 150. Each client 155 is equipped with a browser 160 to view and edit map data retrieved from the geographic information system 100.

The geographic information system 100 includes at least one database 165, a geo front end 103, and at least one geographic information server 105. Although only two databases 165 are shown, in practice, there may be many databases or other data storage facilities that store data for the geographic information system 100. Likewise, a single geographic information server 105 is shown, but in practice, there may be many geographic information servers 105 in operation.

The databases 165 contain map data. Although the two databases 165 are shown as being internal to geographic information system 100, any type of data storage system, including local, remote, and distributed data storage systems can be used. Map data includes geographic data, such as latitude, longitude, elevation, location of geographic features of interest (e.g., bodies of water, mountains, forests); political data, such as country, state, and city boundaries; locations of roads and points of interest (e.g., government buildings, universities, stadiums), address numbering on streets; and attributes of features, such as whether an area is public and the nature of a surface of a street. The map data includes map features.

A map feature is one entry in a map database corresponding to an item on a map. The features of the map are generally represented by points, lines, or polygons. Examples of common map features include an intersection, a road, a landmark, a neighborhood, a park, a public transportation station, and a building. Examples of polygonal map features include political territories such as districts, cities, states, and countries, as well as non-political areas such as malls, complexes, and campuses. The polygonal map features may represent an address component itself (e.g., the polygon of a city represents the city), and may have one or more address components designated for it, such as street, city, state, zip code, country, etc.

Each map feature is indexed by location, and may include an address. Each address is composed of one or more address components, such as street, city, state, country, zip code, and the like. In some cases, some of the map data has been entered into the database 165 by users of the geographic information system 100. In one implementation, separate databases are maintained for data obtained through different sources. For example, one database may contain map data from a government source, and another database may contain data entered by users of the geographic information system 100. Some sources of data may be more authoritative than others. Accordingly, the source of the map data may also be stored with the map data, for example for use in moderating or curating the map data.

The geo front end 103 manages interactions between the clients 155 and the geographic information system 100. The geo front end 103 relays requests received from a client 155 to the geographic information server 105 and provides data retrieved from the databases 165 by the geographic information server 105 back to the client 155.

The geographic information server 105 serves map data from the databases 165 to clients 155. The geographic information server 105 includes a geocoding module 106, an address component matching module 107, and a risk assessment module 108.

The geocoding module 106 determines the geolocation (e.g., the latitude/longitude coordinates) of a map feature based on where it is drawn on the user's screen, and is one means for performing this function. In one implementation, the geocoding module 106 converts the x,y position on the user's screen relative to the origin of the view port to the corresponding latitude and longitude values. The geocoding module 106 may also perform reverse geocoding, which is to find all features that contain that latitude and longitude value. Embodiments of the invention provide improvements to the reverse geocoding process to generate address components of a map feature.

The address component matching module 107 determines the strength of a match between an address component of a polygonal feature covering the location of a selected map feature or near the location of a selected map feature, and is one means for performing this function. In one embodiment, the set of polygonal features can be filtered to include only those polygonal features that appear as address components, e.g. city, state, country and zip code. If the polygons for all of these features are precisely correct, it is expected to find exactly one feature of each type (i.e., one city, one state, one country, one zip code) for every point on the map. It is noted that political feature polygons are likely to have errors when they are created by crowdsourcing. For example, there are few visible markers in map data to indicate where the edge of a zip code area should be. Thus, it is likely that the edge indicated by a user is merely approximate. On the other hand, where a political feature is known to have a border that is visible on satellite imagery (e.g., a river that separates two states), it is likely that that portion of the political feature's boundary is accurate because the map data provides users a reference to draw the polygon. If the polygons are not precisely correct, there may be locations covered by more than one city feature, for example.

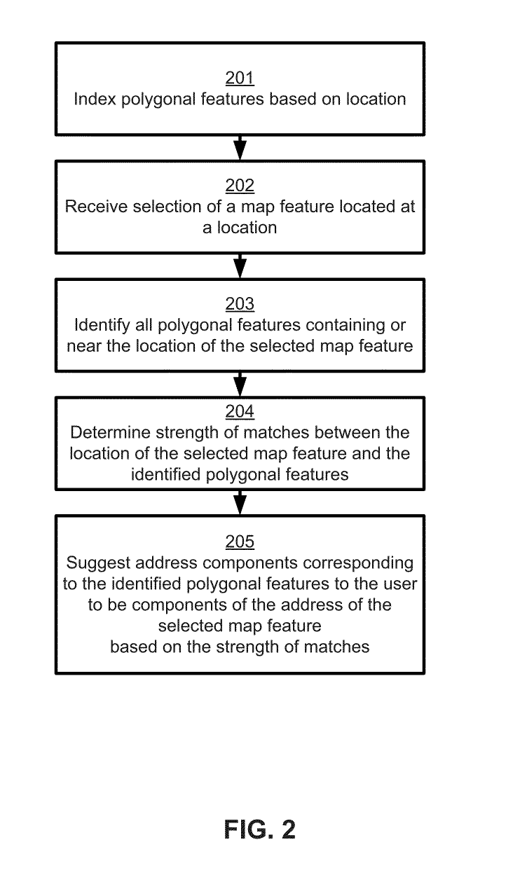

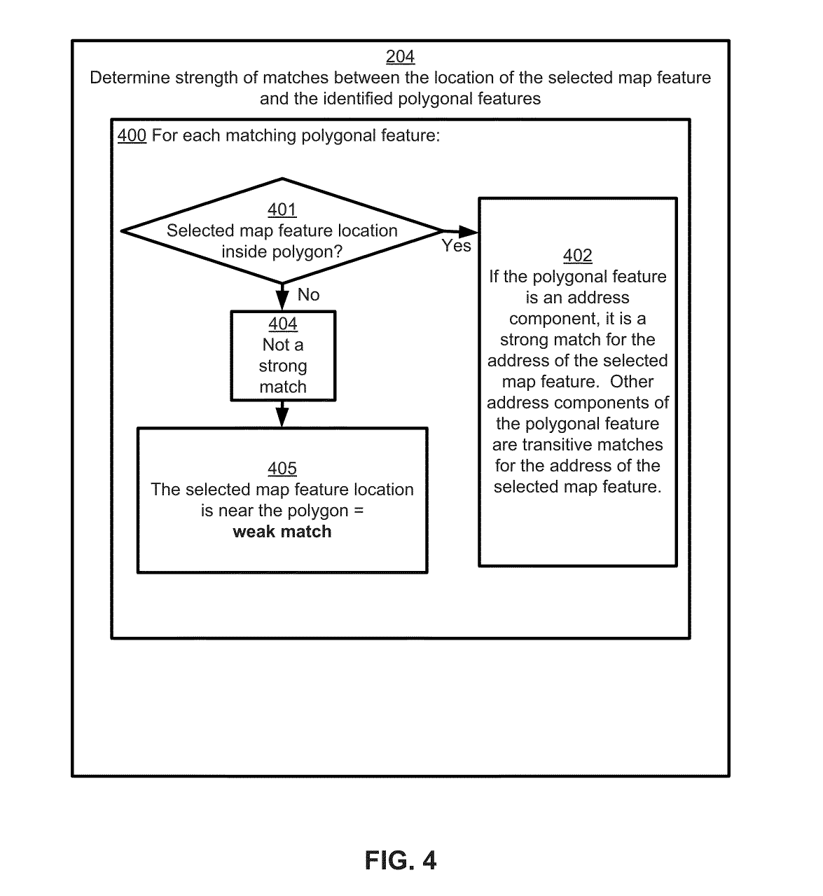

The strength of a match determined by the address component matching module 107 can be used to determine which options to suggest to a user as possible options for an address component of an edited or added feature to the map data. Techniques for determining suggested address components based on the strength of matches are described below with reference to FIGS. 2 and 4.

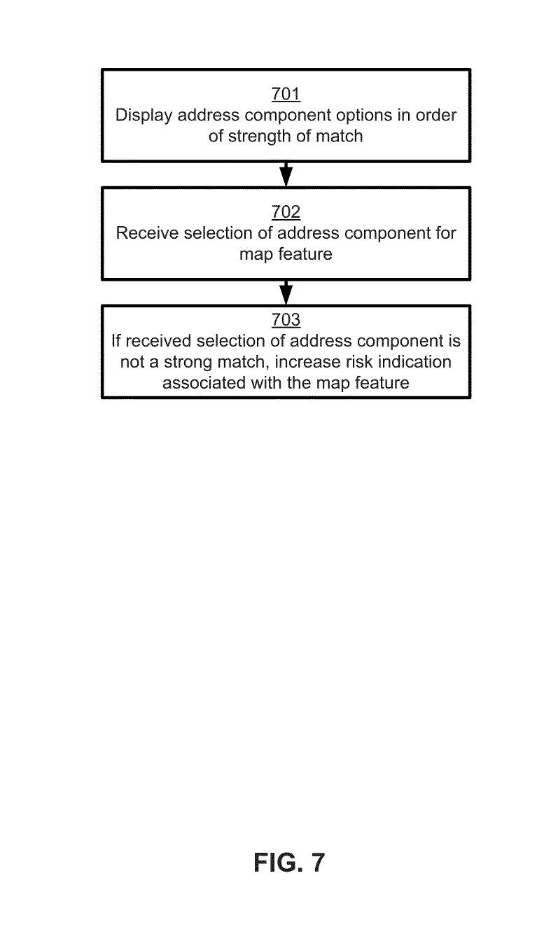

The risk assessment module 108 of the geographic information server 105 assigns a risk to a proposed edit to the map data, based at least in part on the strength of a match used for an address component, and is one means for performing this function. As will be described in greater detail with respect to FIG. 7, if a selection of an address component by a user is not a strong match, the edit to the map feature is marked as being a higher risk of containing an error. Accordingly, the edit to a map feature marked as higher risk may receive special attention from a moderator who reviews map edits for quality assurance.

### Semi-Automatic Address Component Generation

FIG. 2 is a flow chart illustrating a method of suggesting address components for an address of a selected map feature, in accordance with an embodiment. As a preliminary step, polygonal features of the map are indexed 201 based on location. Thus, for any location on a map, it can be quickly determined which polygonal features include or are near the location.

To establish the index, in one embodiment, the entire geographic area described by the geographic information system 100 is divided into cells, each of which represents a portion of the geographic area. At the lowest zoom level, level 1, the entire geographic area is divided into a small number of cells, for example six cells, each representing a relatively large area. At the next zoom level, level 2, the area of each cell from level 1 is divided into four smaller cells, each covering ¼^{th} of the area of a level 1 cell. This regular sub-division, whereby each cell is sub-divided into four smaller cells is repeated for a predetermined number of levels, forming a hierarchy of levels. This hierarchy of cells is similar to a quad-tree arrangement. This organization recursively divides each cell of a given level of detail (the parent) into 4 cells (the children) at the next highest level of detail, each of which cover approximately ¼ the area of the parent cell. In one embodiment, there are six square map portions at a first level covering the entire surface of the Earth, and there are 21 additional zoom levels resulting in approximately 2.64×10¹³ cells at level 22, which are each approximately 4.4 m².

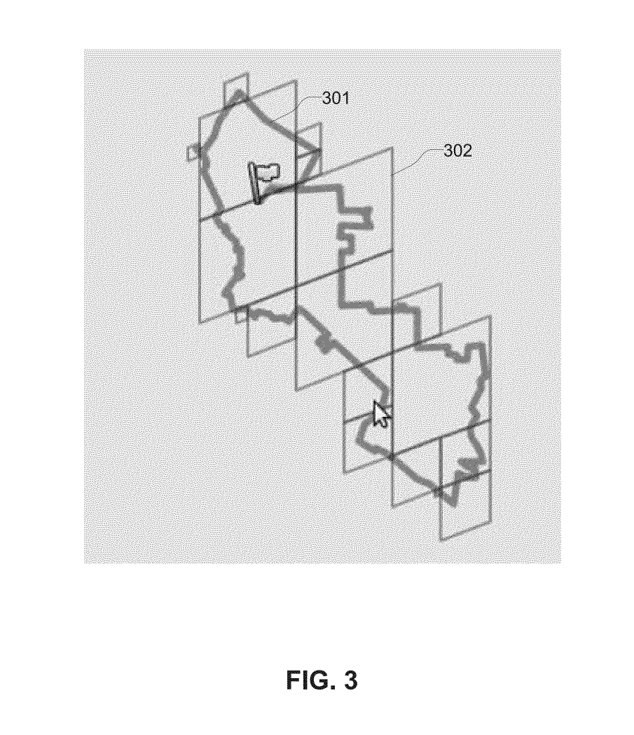

Accordingly, in this hierarchy of cells, every polygon can be indexed based on the cells which are covered by the polygon. In one embodiment, every cell is included that encompasses a boundary of the polygon. An example of an indexed polygonal feature 301, showing the cells 302 that cover the polygon is shown in FIG. 3. In one implementation, a range of zoom levels is used to compute a covering of the polygonal feature, for example levels 16 through 12, and a maximum number of cells is also established for the covering, for example 40 cells. Then, the cells are found that approximate the entire polygon as tightly as possible such that there are no cells smaller than level 16 and no cells larger than level 12. For example, the cells 302 that cover the polygon shown in FIG. 3 have 5 different cell sizes (i.e., from 5 different zoom levels). Also, if each cell that is shown in the picture is subdivided into its four children, in most cases some part of the polygon will overlap each of the four children, so it would not be possible to pick a tighter covering of the polygon that included three out of the four children. In some cases, even if it were to be possible to obtain a tighter covering of the polygon by including three out of the four children, the single parent cell may still be used instead of the three children because of the a limit on the total number of cells, for example not to exceed 40 cells. As a result, the covering is merely an approximation of the polygon. There is a tradeoff between efficiency in terms of the number of cells needed to cover the polygon and the precision with which the polygon is covered.

Referring again to FIG. 2, a selection of a map feature located at a location is received 202. A user may make a selection in connection with proposing a new map feature or an edit to an existing map feature. In either case, the location of the selected feature is received from the user's input or interpreted by the geocoding module 106 of the geographic information server 105.

Once the location of the selected map feature is known, all polygonal features containing or near the location of the selected map feature are identified 203. Recall that the polygonal features were indexed based on location, for example, based on the cells that are covered by the polygon. In one implementation, a query is executed for all polygonal features indexed for the cells at any level that contain or are near the location of the selected map feature. In another implementation, only cells between certain levels, for example levels 12 to 16, are considered. In this case, the levels chosen for indexing the polygons are the same levels chosen for querying for polygonal features, and the range of levels is selected for efficiency for both large and small polygons. The results of this query are referred to herein as the matching polygonal features for the location of the selected map feature. At least one matching polygonal feature is identified 203 in order to proceed with the method.

After the polygonal features containing or near the location of the selected map feature are identified 203, the strength of the matches between the location of the selected map feature and the identified polygonal features are determined. In one implementation, a match is deemed strong if the location of the selected map feature is contained in the polygon of the matching polygonal feature, and a match is deemed weak if the location of the selected map feature is not contained in the polygon but is merely close to it. For example, if the location of the selected map feature is within a threshold distance from a geometric center point of the polygon or a threshold distance from a boundary of the polygon, it may be deemed a weak match, whereas if the selected map feature is not within the threshold distance, it is not a match. The threshold distances may vary depending on the type of polygonal feature, and generally the larger the polygon, the larger the threshold distance. For example, a threshold distance of 200 meters may be established for weak matches for a neighborhood and 500 meters for weak matches for a city. More detail regarding determining the strength of matches to the identified polygonal features is included below with reference to FIG. 4.

Lastly, address components corresponding to the identified polygonal features are suggested 205 to the user to be components of the address of the selected map feature based on the strength of the matches. The suggestions may be presented, for example, in a populated drop down box from which a user can select the appropriate polygonal feature. In one embodiment, the address component options for each component are presented in order based on the strength of the match, with one or more strong matches presented first, followed by weak matches, followed by transitive matches, which will be described in greater detail below, with reference to FIGS. 4-6.

FIG. 4 is a flow chart illustrating a method of determining 204 the strength of matches between the location of the selected map feature and the identified polygonal features, in accordance with an embodiment. The following method is iterated for each matching polygonal feature 400 identified 203 as containing or near the location of the selected map feature. For each matching polygonal feature 400, it is determined whether the location of the selected map feature is inside the polygonal feature 401. This can be performed, for example, by address component matching module 107 of the geographic information system 100.

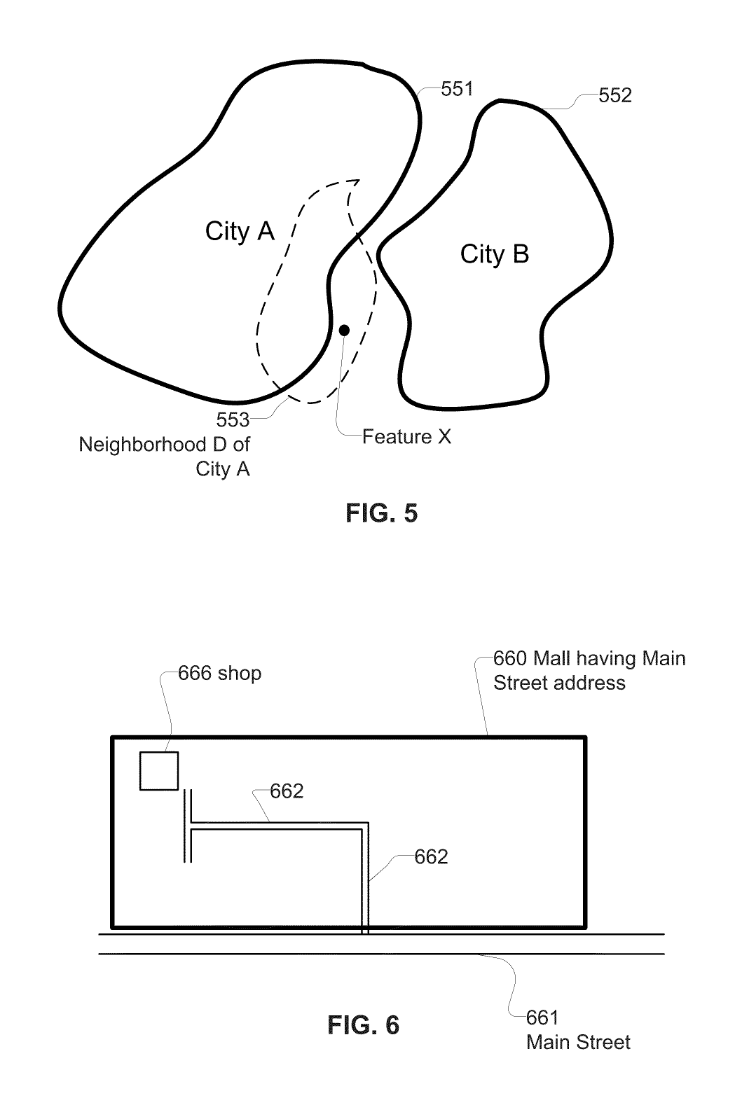

If the location of the selected map feature is inside of the polygonal feature, and if the polygonal feature is an address component itself (e.g., a country, state, city, zip code, etc.), then it is a strong match for the corresponding address component of the selected map feature 402. For example, if the polygonal feature is the polygon marking the area of a city, for example Washington, D.C., and the location of the selected map feature, for example the location of a monument, is inside of the city polygon for Washington, D.C., then Washington, D.C., is a strong match for being the city address component of the selected map feature. In other words, Washington, D.C., should be suggested as an option to the user to select as the city address component for the monument map feature. The other address components of a strongly matched polygonal feature and the address components of other polygons that are not themselves an address component are all transitive matches for the address of the selected map feature. Examples of polygonal features that may not appear as address components themselves are a neighborhood, a campus, a mall, a complex, etc. Examples of transitive matches are described below with reference to FIGS. 5 and 6.

Referring again to FIG. 4, if the location of the selected map feature is not inside the polygonal feature, then the polygonal feature is not a strong match 404. Accordingly, the location of the selected map feature is merely near the polygon of the polygonal feature, and is thus a weak match 405. A match deemed to be “weak” is an indication of how likely it is that the address components corresponding to the weakly matching polygon are the proper address components of the map feature selected by the user. A strong match is more likely to generate the proper address component of the map feature selected by the user as compared to a weak match. In one implementation, the address components of weak matches may be considered as transitive matches. Such transitive matches may be even less likely to generate the proper address component of the map feature than transitive matches that are obtained from strong matched features.

FIG. 5 is an illustration of City A being a transitive match for the city address component of feature X based on feature X's position inside the polygon 553 marking Neighborhood D. In this case, it can be determined that feature X is not inside the polygon 551 for City A, nor the polygon 552 for City B. Thus, feature X will not be a strong match with City A nor City B. Depending on how near feature X is to City A or City B, it may or may not be a weak match for one of more of those cities based on the threshold distance from the city boundary or the geometric center point of the city. However, feature X does fall within the polygon 553 for neighborhood D. Neighborhood D has City A recorded as its city address component. Thus, City A is a transitive match for the city address component of feature X.

FIG. 6 is an illustrated example of a mall street address being a transitive match for a street address component of a shop 666 based on the shop's position inside of the polygon 660 marking the mall. In this example, the selected map feature is the shop 666. The shop 666 is inside the polygon 660 marking the grounds of the mall. The address components of the mall are transitive matches for the address of the shop 666. In this example, the mall has an address on Main Street 661. Thus, Main Street is a transitive match for the street address component of the shop 666, despite other streets 662 which may be closer in proximity to the location of the shop 666. In some cases, the address of a larger, more important, or more traveled road may be preferred as the address of a shop within a mall, because it may be more recognizable to the public than the names of interior driveways or alleys within the grounds of a larger complex. In this example, the transitive match to Main Street as the street address component is presented as an option to the user editing the shop feature 666.

FIG. 7 is a flow chart illustrating a method of modifying a risk associated with a user's edit, in accordance with an embodiment. First, address component options are displayed 701 for a map feature in order of the strength of the match. In one embodiment, strong matches for an address component are displayed at the top of the list, followed by weak matches, followed by any transitive matches. In another embodiment, strong matches are displayed at the top of the list, followed by transitive matches, followed by weak matches. An example of when a transitive match may be preferable to a weak match occurs when a boundary of a City M is drawn coarsely and is near a mall. A store S is located inside the mall. The mall has an address of City N, and the boundary of City N overlaps part of the mall but does not fully include it. The store S is located in the mall portion that falls in the area not covered by City M or City N. If City N is small while City M is large, the weak match region of City M may be large enough to cover the store while the weak match region for City N may not be large enough to cover the store. In this case, the transitive match for City N is more likely to be the proper city designation than the weak match of City M. If the proper containment relationship between the store S and the mall is recognized, the transitive match may be promoted over weak matches. If, on the other hand, the store S was inside of a polygon marking a voting district having a city designated as City N, it may be preferable to promote the weak match of City M as more likely to be the proper city designation than the transitive match to City M from the voting district because containment inside a voting district has no bearing on the feature's address.

Then, a selection of an address component for the map feature is received 702. For example, a user may select one of the displayed address component options from a drop down menu or the like. Once the selection is made, it is transmitted from the user's client device 155 to the geographic information system 100.

Lastly, if the received selection of an address component for the map feature is not a strong match, then a risk indication associated with the edit to the map feature is increased 703. The edit to the map feature is recorded as a higher risk edit than if the user selected an address component for the map feature that was a strong match. In one embodiment, the strength of the match was determined by the address component matching module 107 of the geographic information server 105. Then, the risk assessment module 108 adjusts a risk signal associated with the edit to the map feature based on the strength of the match that generated the address component for the map feature that was selected by the user. If the user selects an address component that is not a strong match, the edit to the map feature is recorded as higher risk because it is deemed to be more likely to contain an error. Alternatively, an edit to the map feature is only recorded as higher risk if the user selects an address component that is not a strong match despite the fact that a strong match exists. Otherwise, in some implementations, no extra risk is assumed based on the user's selection of a weak or transitive match when no strong match exists. Additionally or alternatively, the amount of risk may vary based on the political level of the address component, with lower level components such as localities being less risky than higher level components such as country.

The edit to a map feature marked as higher risk may receive special attention from a moderator who reviews map edits for quality assurance. The special attention may include additional processing, such as a higher level scrutiny by one or more moderators before the edit is approved. By paying special attention to riskier edits, the propagation of errors in the map data is less likely. Thus, individual contributors can operate largely independently to enhance to comprehensiveness of the map data, and the quality of the map data does not suffer as a result.

### Additional Configuration Considerations

The present invention has been described in particular detail with respect to several possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method of generating address components for an address of a selected map feature, the method comprising:
receiving a selection of a map feature located at a location;
identifying at least one polygonal feature near the location of the selected map feature, wherein the identified polygonal feature defines a boundary on a map and the location of the selected map feature is outside of the boundary defined by the identified polygonal feature;
for an identified polygonal feature, determining a strength of a match between the location of the selected map feature and the identified polygonal feature;
generating one or more address components for the map feature from the at least one identified polygonal feature based on the strength of the match; and
displaying the one or more generated address components corresponding to the identified polygonal features in an ordered list based on the strength of the match.

2. The method of claim 1, wherein a polygonal feature is near the location of the selected map feature if the selected map feature is within a threshold distance from a boundary of the polygonal feature.

3. The method of claim 2, wherein the threshold distance depends on a size of the polygonal feature.

4. The method of claim 2, wherein the threshold distance depends on a type of the polygonal feature near the location of the selected map feature.

5. The method of claim 1, wherein a polygonal feature is near the location of the selected map feature if the selected map feature is within a threshold distance from a geometric center of the polygonal feature.

6. The method of claim 5, wherein the threshold distance depends on a size of the polygonal feature.

7. The method of claim 5, wherein the threshold distance depends on a type of the polygonal feature near the location of the selected map feature.

8.-9. (canceled)

10. The method of claim 1, further comprising:
receiving a selection from the list of generated address components from a user; and
calculating a risk associated with the selection of the address component based on the strength of the match to the identified polygonal feature corresponding to the selected generated address component.

11. The method of claim 10, further comprising:
responsive to a received selection of an address component that is not a strong match, increasing a risk indication associated with the selected map feature.

12. The method of claim 1, wherein the identified polygonal feature represents a particular type of address component and has a recorded value for the particular type of address component, and wherein determining a strength of a match between the location of the selected map feature and the identified polygonal feature further comprises:
identifying a second polygonal feature defining a second boundary on the map, wherein the location of the selected map feature is within the second boundary defined by the second polygonal feature, and wherein the second polygonal feature has the recorded value for the particular type of address component but does not represent the particular type of address component;
responsive to the location of the selected map feature being inside the second boundary defined by the identified second polygonal feature, determining that the recorded value of the particular type of address component associated with the identified polygonal feature is a transitive match with the selected map feature.

13. (canceled)

14. A computer program product comprising a non-transitory computer-readable storage medium containing executable computer program code for generating address components for an address of a selected map feature, the code executable for:
receiving a selection of a map feature located at a location;
identifying at least one polygonal feature near the location of the selected map feature, wherein the identified polygonal feature defines a boundary on a map and the location of the selected map feature is outside of the boundary defined by the identified polygonal feature;
for an identified polygonal feature, determining a strength of a match between the location of the selected map feature and the identified polygonal feature;
generating one or more address components for the map feature from the at least one identified polygonal feature based on the strength of the match; and
displaying the one or more generated address components corresponding to the identified polygonal features in an ordered list based on the strength of the match.

15. The computer program product of claim 14, wherein a polygonal feature is near the location of the selected map feature if the selected map feature is within a threshold distance from a boundary of the polygonal feature.

16. The computer program product of claim 15, wherein the threshold distance depends on a size of the polygonal feature.

17. The computer program product of claim 15, wherein the threshold distance depends on a type of the polygonal feature near the location of the selected map feature.

18. The computer program product of claim 14, wherein a polygonal feature is near the location of the selected map feature if the selected map feature is within a threshold distance from a geometric center of the polygonal feature.

19. The computer program product of claim 18, wherein the threshold distance depends on a size of the polygonal feature.

20. The computer program product of claim 18, wherein the threshold distance depends on a type of the polygonal feature near the location of the selected map feature.

21.-22. (canceled)

23. The computer program product of claim 14, the computer program code further comprising computer program code for:
receiving a selection from the list of generated address components from a user; and
calculating a risk associated with the selection of the address component based on the strength of the match to the identified polygonal feature corresponding to the selected generated address component.

24. The computer program product of claim 23, the computer program code further comprising computer program code for:
responsive to a received selection of an address component that is not a strong match, increasing a risk indication associated with the selected map feature.

25. The computer program product of claim 14, wherein the computer program code for determining a strength of a match between the location of the selected map feature and the identified polygonal feature further comprises computer program code for:
identifying a second polygonal feature defining a second boundary on the map, wherein the location of the selected map feature is within the second boundary defined by the second polygonal feature, and wherein the second polygonal feature has the recorded value for the particular type of address component but does not represent the particular type of address component;
responsive to the location of the selected map feature being inside the second boundary defined by the identified second polygonal feature, determining that the recorded value of the particular type of address component associated with the identified polygonal feature is a transitive match with the selected map feature.

26. (canceled)
